(19) United States
(12) Patent Application Publication
(10) Pub. No.: US 2017/0270343 A1
(43) Pub. Date: Sep. 21, 2017

(54) FINGERPRINT RECOGNITION MECHANISM AND ELECTRONIC DEVICE

(71) Applicant: EverDisplay Optronics (Shanghai) Limited, Shanghai (CN)

(72) Inventors: Sheng-Yu LAI, Shanghai (CN); Yu-Ming LIN, Shanghai (CN)

(73) Assignee: EverDisplay Optronics (Shanghai) Limited, Shanghai (CN)

(21) Appl. No.: 15/447,796

(22) Filed: Mar. 2, 2017

(30) Foreign Application Priority Data
Mar. 17, 2016 (CN) 201610152544.9

(51) Int. Cl. G06K 9/00; G06F 3/041

(52) U.S. Cl. CPC G06K 9/00053; G06K 9/00087; G06F 3/041

(57) ABSTRACT

The present disclosure relates to a fingerprint recognition mechanism and an electronic device. The fingerprint recognition mechanism includes: a base plate; a cover plate disposed over and separated from the base plate; a touch panel disposed over the cover plate; and a fingerprint recognition unit disposed between the base plate and the cover plate to emit electrical signals and recognize biometric features; wherein the fingerprint recognition unit includes: a fingerprint module disposed below the cover plate and corresponding to a fingerprint sensing region of the touch panel; and a signal transmission layer electrically coupled with the fingerprint module and configured to transmit the electrical signals to a part of limbs of a user, wherein the electrical signals are transmitted to another part of the limbs through the user so that the fingerprint module recognizes biometric features of the another part of the limbs of the user.

### CROSS-REFERENCE TO RELATED APPLICATIONS

This application claims priority to Chinese Patent Application No. 201610152544.9, filed Mar. 17, 2016, the entire contents of which are incorporated herein by reference.

### TECHNICAL FIELD

The present disclosure generally relates to fingerprint recognition technologies, and more particularly to, a fingerprint recognition assembly and an electronic device having the fingerprint recognition assembly.

### BACKGROUND

Mobile terminals are widely applied in people's daily life. Present mobile terminals have more and more powerful functions, which brings great convenience to users. However, while providing convenience to users, mobile terminals carry too much private information, and if one mobile terminal is lost or stolen and the information carried by the mobile terminal is not secured well, the information is easy to be leaked. This will cause great inconvenience to users. Thus, it seems necessary to provide some privacy settings on mobile terminals.

Fingerprint recognition is one of the best solutions for user identification in mobile terminals such as mobile phones due to uniqueness and safety. Existing mobile phones available on market usually have a fingerprint recognition mechanism embedded into a panel of the mobile phones. FIG. 1 is a schematic diagram showing a structure of a conventional fingerprint recognition mechanism. As shown in FIG. 1, the conventional fingerprint recognition module delivers electrical signals to user's finger by a metal ring 11 around a fingerprint sensing region, and the electrical waves reflected by the finger are transmitted to the fingerprint sensing region 12 for sensing peaks and valleys of fingerprint. In this way, fingerprint recognition is realized. As can be seen from the above description, the conventional fingerprint recognition mechanism needs to cut a hole below the panel of a mobile phone to enable the fingerprint recognition mechanism to be embedded into the hole. Such solution is time-consuming and involves too much work, and yield of assembly may be influenced.

### SUMMARY

Aiming at the shortcomings in conventional technologies, embodiments of the present disclosure provide a fingerprint recognition mechanism and an electronic device having the fingerprint recognition mechanism. Using the fingerprint recognition mechanism, it is not necessary to cut a hole below a cover plate of the electronic device to embed the fingerprint recognition mechanism therein, thereby simplifying manufacturing processes, saving costs, and achieving a concise and pretty form in which a cover plate of the fingerprint recognition mechanism and the cover plate of the electronic device are formed integrally.

According to an aspect of embodiments of the present disclosure, there is provided a fingerprint recognition mechanism, including:
a base plate;
a cover plate disposed over and separated from the base plate;
a touch panel disposed over the cover plate; and
a fingerprint recognition unit disposed between the base plate and the cover plate to emit electrical signals and recognize biometric features;
wherein the fingerprint recognition unit includes:
a fingerprint module disposed below the cover plate and corresponding to a fingerprint sensing region of the touch panel;
a signal transmission layer electrically coupled with the fingerprint module and configured to transmit the electrical signals to a part of limbs of a user, wherein the electrical signals are transmitted to another part of the limbs through the user so that the fingerprint module recognizes biometric features of the another part of the limbs of the user.

Optionally, the signal transmission layer includes:
a conductive layer disposed below the cover plate and electrically coupled with the fingerprint module; and
a conductive frame disposed between the base plate and the cover plate and electrically coupled with the conductive layer.

Optionally, the fingerprint recognition unit further includes a protection layer disposed on a surface of the fingerprint module and between the fingerprint module and the cover plate.

Optionally, the protection layer is made of transparent optical adhesive.

Optionally, the fingerprint module is attached to the cover plate via the protection layer.

Optionally, the fingerprint recognition unit further includes an insulating layer disposed between the signal transmission layer and the cover plate.

Optionally, the electrical signals emitted from the fingerprint recognition unit are carrier waves of 100 KHz to 1 MHz.

Optionally, a plurality of fingerprint sensors are provided in the fingerprint module.

Optionally, the conductive layer is made of aluminum, copper, silver or indium tin oxide.

Optionally, the conductive frame is made of aluminum alloy or aluminum-magnesium alloy.

Optionally, the conductive layer and the conductive frame are formed integrally.

Optionally, the cover plate is formed by thin glass material.

According to another aspect of embodiments of the present disclosure, there is provided an electronic device having a fingerprint recognition function, including one of the above-mentioned fingerprint recognition mechanisms.

Optionally, the fingerprint recognition unit is disposed in a non-display region of the electronic device.

Optionally, the fingerprint recognition unit is disposed at the bottom of the electronic device.

Optionally, the conductive frame and a frame of the electronic device are formed integrally.

Optionally, the cover plate and a cover plate of the electronic device are formed integrally.

Optionally, the electronic device is a mobile phone.

According to another aspect of embodiments of the present disclosure, there is provided a fingerprint recognition method using one of the above fingerprint recognition mechanisms, including:
emitting electrical signals by the fingerprint module;
transmitting the electrical signals via the signal transmission layer to a part of limbs of a user, wherein the electrical signals is then transmitted to another part of the limbs through the user; and
recognizing, by the fingerprint module, biometric features of the another part of the limbs of the user acting upon the touch panel.

Optionally, the electrical signals are transmitted from to one hand of the user and then to another hand of the user for recognition of biometric features.

In the fingerprint recognition mechanism and electronic device having the fingerprint recognition mechanism provided by embodiments of the present disclosure, the frame of the fingerprint recognition mechanism and the frame of the electronic device are formed integrally, that is, (a part of) the frame of the electronic device also serves as the frame of the fingerprint recognition mechanism As such, the fingerprint recognition mechanism can be disposed in the electronic device without being embedded into the electronic device. It can be seen that the fingerprint recognition mechanism in the present disclosure at least has the following advantages over conventional technologies:
(1) The fingerprint recognition mechanism can be disposed in the electronic device without being embedded into the electronic device, and thus it is not necessary to cut a hole below the cover plate of the electronic device.
(2) The fingerprint sensing region of the fingerprint recognition mechanism and the fingerprint sensing region of the electronic device are formed integrally, thereby achieving a narrow bezel and also a concise and pretty form of the electronic device.
(3) The fingerprint recognition mechanism is directly attached below the fingerprint sensing region, and thus the manufacture processes are simplified, and the assembling becomes convenient and costs can be reduced.

### BRIEF DESCRIPTION OF THE DRAWINGS

The above and other features and advantages of the present disclosure will become clearer from detailed descriptions of exemplary embodiments with reference to drawings.

FIG. 1 is a schematic diagram showing a structure of a conventional fingerprint recognition mechanism.

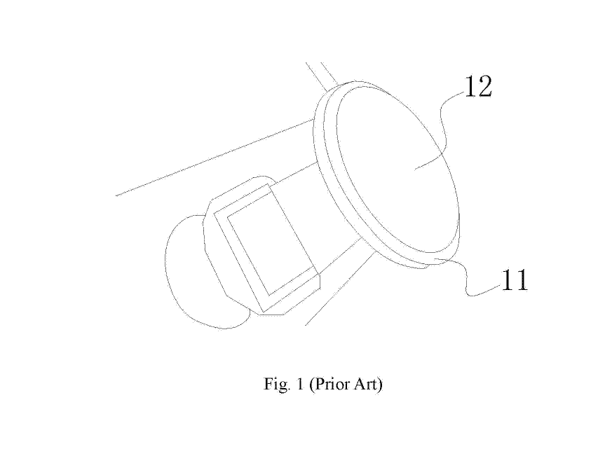

FIG. 2a is cross-sectional view of a fingerprint recognition mechanism according to an embodiment of the present disclosure.

FIG. 2b is a partial enlarged view of FIG. 2a.

FIG. 3 is a flowchart showing a fingerprint recognition method using the fingerprint recognition mechanism according to an embodiment of the present disclosure.

FIG. 4 is a cross-sectional view when the fingerprint recognition mechanism recognizes a fingerprint according to an embodiment of the present disclosure.

FIG. 5 is a front view of an electronic device according to an embodiment of the present disclosure.

FIG. 6 is a schematic diagram showing a state when the electronic device according to an embodiment of the present is used to recognize a fingerprint.

### DETAILED DESCRIPTION

According to the design principle of the present disclosure, a fingerprint recognition mechanism according to an embodiment of the present disclosure may include: a base plate; a cover plate disposed over and separated from the base plate; a touch panel disposed over the cover plate; and a fingerprint recognition unit disposed between the base plate and the cover plate to emit electrical signals and recognize biometric features; wherein the fingerprint recognition unit may include: a fingerprint module disposed below the cover plate and corresponding to a fingerprint sensing region of the touch panel; and a signal transmission layer electrically coupled with the fingerprint module and configured to transmit the electrical signals to a part of limbs of a user, wherein the electrical signals are transmitted to another part of the limbs through the user so that the fingerprint module recognizes biometric features of the another part of the limbs of the user.

The technical contents of the present disclosure will be described in detail with reference to drawings and exemplary embodiments.

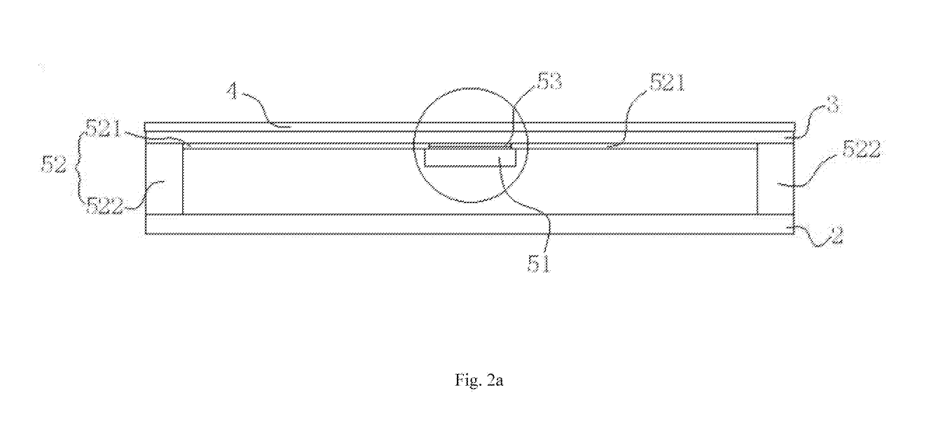

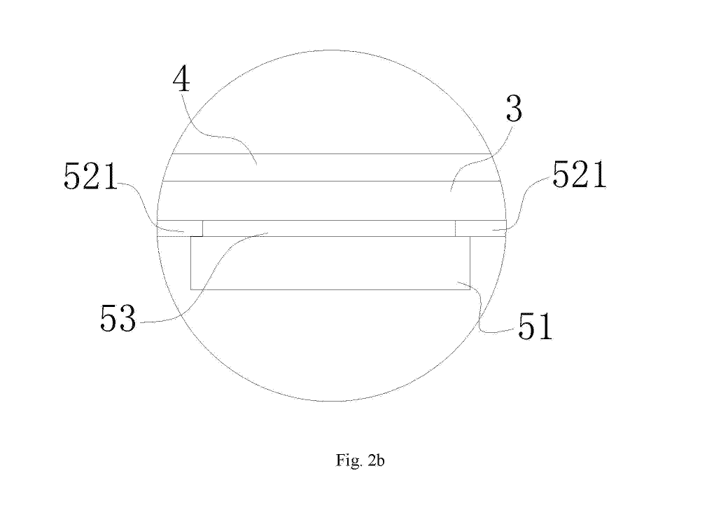

FIGS. 2a and 2b are cross-sectional views of a fingerprint recognition mechanism according to an embodiment of the present disclosure. As shown in FIGS. 2a and 2b, in an exemplary embodiment of the present disclosure, the fingerprint recognition mechanism includes a base plate 2, a cover plate 3, a touch panel 4 and a fingerprint recognition unit.

The cover plate 3 is disposed over and separated from the base plate 2. Optionally, the cover plate is formed by thin glass material (for example, thin glass plate).

The touch panel 4 is disposed over the cover plate 3. Optionally, the touch panel 4 is disposed over and attached onto the cover plate 3. The cover plate 3 and the touch panel 4 have a fingerprint sensing region (for example, the region of the HOME button of the mobile phone). The user can place his/her finger on the fingerprint sensing region, and then the fingerprint recognition unit can recognize biometric features (for example, fingerprint).

The fingerprint recognition unit is disposed between the base plate 2 and the cover plate 3 to emit electrical signals and recognize biometric features (for example, fingerprint) in the fingerprint sensing region on the touch panel 4. Specifically, the fingerprint recognition unit may include a fingerprint module 51 and a signal transmission layer 52.

The fingerprint module 51 is disposed below the cover plate 3 and is located as corresponding to the fingerprint sensing region of the touch panel 4 and the cover plate 3. The fingerprint module 51 emits electrical signals (for example, driving signals) and recognizes biometric features (for example, fingerprint) in the fingerprint sensing region on the touch panel 4. A plurality of fingerprint sensors 511 are provided in the fingerprint module 51. Optionally, the electrical signals emitted from the fingerprint module 51 of the fingerprint recognition unit are carrier waves of 100 KHz to 1 MHz.

The fingerprint recognition unit may further include a protection layer 53 which is disposed on a surface of the fingerprint module 51, is attached to the fingerprint module 51 and is disposed between the fingerprint module 51 and the cover plate 3. The protection layer 53 may be made of materials such as transparent optical adhesive. The fingerprint module 51 is attached to the cover plate 3 via the protection layer 53.

The signal transmission layer 52 is electrically coupled with the fingerprint module 51 to deliver the electrical signals emitted from the fingerprint module 51 to the user. The signal transmission layer 52 may include a conductive layer 521 and a conductive frame 522.

The conductive layer 521 is disposed below the cover plate 3 and electrically coupled with the fingerprint module 51. Optionally, the conductive layer 521 is made of materials such as aluminum, copper, silver or indium tin oxide. In the exemplary embodiment as shown in FIGS. 2a and 2b, the conductive layer 521 is attached to the bottom surface of the cover plate 3, but disposing of the conductive layer 521 in the fingerprint sensing region of the cover plate 3 and the touch panel 4 is avoided. The fingerprint module 51 is disposed below the conductive layer 521.

The conductive frame 522 is disposed between the base plate 2 and the cover plate 3 and is electrically coupled with the conductive layer. Optionally, the conductive frame 522 is made of materials such as aluminum alloy or aluminum-magnesium alloy. The conductive frame 522 may be connected with both sides of the conductive layer 521, and may be located at edges of both sides of the base plate 2 and the cover plate 3. In some embodiments, the conductive layer 521 and the conductive frame 522 may be formed integrally using the same material to form the signal transmission layer 52.

The fingerprint recognition unit may further include an insulating layer (not shown). The insulating layer may be disposed between the signal transmission layer 52 and the cover plate 3. The insulating layer may prevent the electrical signals emitted from the fingerprint module 51 from propagating to the cover plate 3 via the signal transmission layer 52.

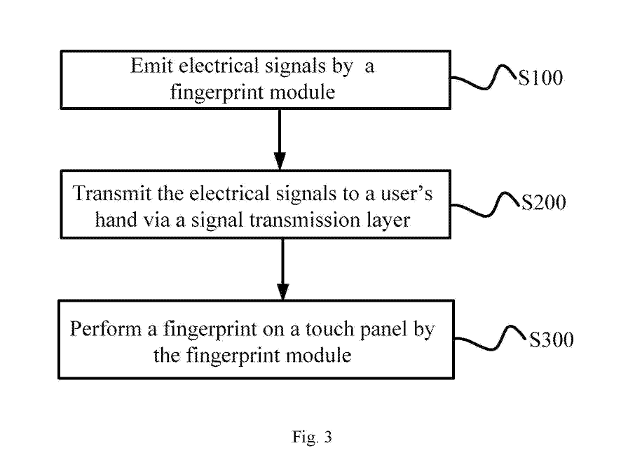

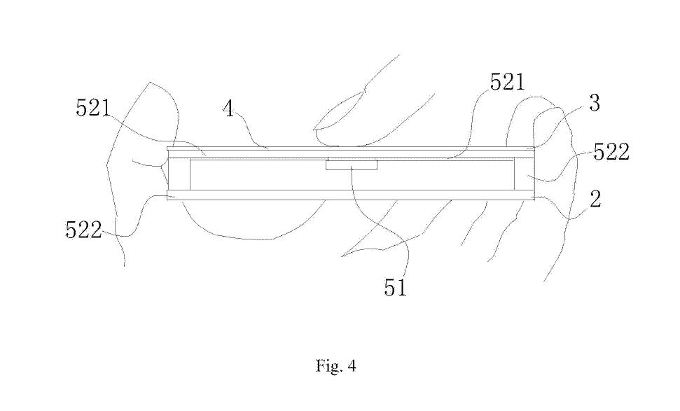

FIG. 3 shows a flowchart of a fingerprint recognition method using the fingerprint recognition mechanism according to an embodiment of the present disclosure. FIG. 4 is a cross-sectional view when the fingerprint recognition mechanism recognizes a fingerprint according to an embodiment of the present disclosure. As shown in FIG. 3, the fingerprint recognition method using the fingerprint recognition mechanism may include the following steps.

In step S100, the fingerprint module 51 emits electrical signals. Specifically, the fingerprint module 51 emits electrical signals to the conductive layer 521 of the signal transmission layer 52.

In step S200, the electrical signals are transmitted to a hand of a user via the signal transmission layer 52. Specifically, during usage, a user may hold the conductive frame 522 of the fingerprint recognition mechanism by one of his/her hands, and the electrical signals emitted from the fingerprint module 51 pass the conductive 521 and the conductive frame 522 and then arrive at the hand of the user.

In step S300, the fingerprint module 51 recognizes the fingerprint on the touch panel. Specifically, the electrical signals transmitted to the hand of the user are transmitted to a finger placed on the fingerprint sensing region of the touch panel, and then the fingerprint module 51 recognizes the fingerprint of the finger placed on the fingerprint sensing region of the touch panel 4.

Optionally, the electrical signals are transmitted to a left hand of the user and then are transmitted to a right hand of the user, and the fingerprint module 51 recognizes the fingerprint of one fingers of the right hand. Or, the electrical signals are transmitted to a right hand of the user and then are transmitted to a left hand of the user, and the fingerprint module 51 recognizes the fingerprint of one fingers of the left hand. In the exemplary embodiment as shown in FIG. 4, the user holds the conductive frame 522 of the fingerprint mechanism with his/her left hand, the fingerprint module 51 emits electrical signals which pass the conductive layer 521 and the conductive frame 522 and then arrive at the left right of the user. Then, the electrical signals are transmitted from the left hand to the right hand of the user. When a finger of the right hand of the user is placed on the fingerprint sensing region of the touch panel 4, the fingerprint module 51 performs fingerprint recognition.

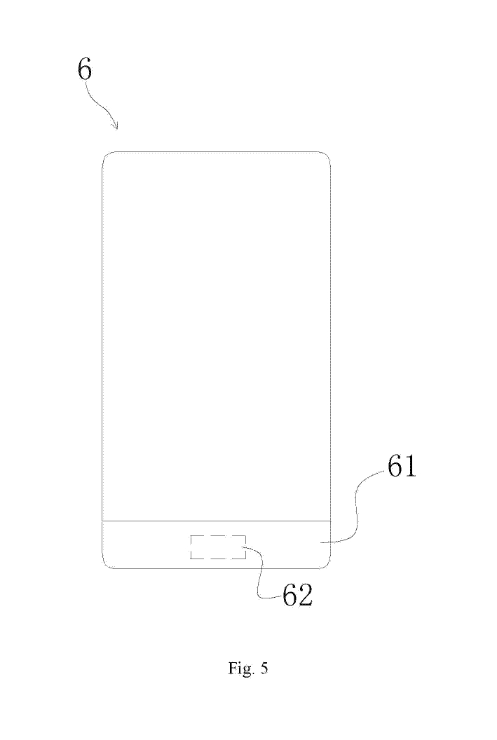

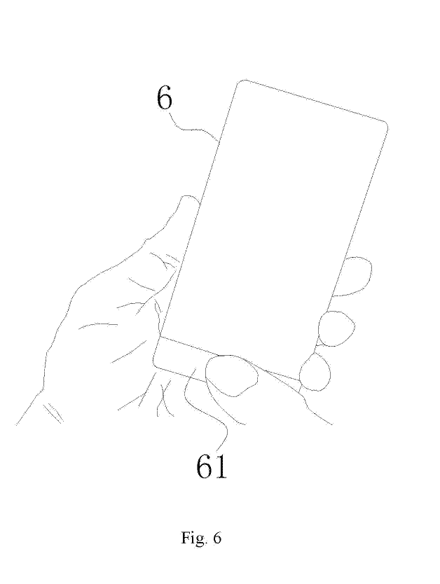

Embodiments of the present further provide an electronic device which uses the fingerprint recognition mechanism as shown in FIGS. 2a and 2b and has a fingerprint recognition/scanning function. FIG. 5 is a front view of an electronic device according to an embodiment of the present disclosure. FIG. 6 is a schematic diagram showing a state when the electronic device according to an embodiment of the present is used to recognize a fingerprint. In the exemplary embodiment as shown in FIGS. 5 and 6, the electronic device may be a mobile phone. The following descriptions will be made with the example of mobile phone.

As shown in FIG. 5, the fingerprint recognition unit is disposed in a non-display region 61 of the mobile phone 6. Optionally, the non-display region is located at the bottom of the mobile phone, and thereby the fingerprint recognition unit is disposed at the bottom of the mobile phone 6. Further, the conductive frame 522 and the frame of the mobile phone 6 are formed integrally, that is, the conductive frame 522 of the fingerprint recognition mechanism also serves as the frame of the mobile phone 6. Correspondingly, the cover plate 3 and the cover plate of the mobile phone 6 are formed integrally, the base plate 2 and the base plate of the mobile phone 6 are formed integrally, and the touch panel 4 and the touch panel of the mobile phone 6 are formed integrally. That is, the base late 2, the cover plate 3 and the touch panel 4 of the fingerprint recognition mechanism also serve as the base plate, the cover plate and the touch panel of the mobile phone 6, respectively. Accordingly, the fingerprint recognition mechanism, as its entity, serves as a part of the mobile phone.

As shown in FIG. 6, when the fingerprint recognition function of the mobile phone 6 is desired, the user holds the frame of the mobile phone 6 (i.e., the conductive frame 522) by his/her left hand. The fingerprint module disposed in the mobile phone 6 emits electrical signals which pass the conductive layer 521 and the frame of the mobile phone 6 (i.e., the conductive frame 522) and then arrive at the left hand of the user. Then, the electrical signals are transmitted from the left hand to the right hand of the user. When the user puts one finger of his/her right hand on the fingerprint sensing region 62 of the touch panel, the fingerprint module 51 recognizes the fingerprint of the finger of his/her right hand.

It shall be appreciated that although exemplary embodiments of the present disclosure are described with fingerprint as an example, the fingerprint recognition mechanism may also recognize other biometric features than fingerprint. For example, the fingerprint recognition mechanism may also recognize textures such as palm print. The above descriptions also apply to the example of palm print and detailed descriptions are omitted here.

Further, one of ordinary skilled in this art shall understand that, in the fingerprint recognition mechanism and the electronic device in the embodiments of the present disclosure, the frame of the fingerprint recognition mechanism and the frame of the electronic device are formed integrally, i.e., the frame of the electronic device also serve as the frame of the fingerprint recognition mechanism. As such, the fingerprint recognition mechanism can be disposed in the electronic device with being embedded into the electronic device. Thus, the fingerprint recognition mechanism in the present disclosure at least has the following advantages over conventional technologies. For example, the fingerprint recognition mechanism can be disposed in the electronic device without being embedded into the electronic device, and thus it is not necessary to cut a hole below the cover plate of the electronic device. The fingerprint sensing region of the fingerprint recognition mechanism and the fingerprint sensing region of the electronic device are formed integrally, thereby achieving a narrow bezel and also a concise and pretty form of the electronic device. The fingerprint recognition mechanism is directly attached below the fingerprint sensing region, and thus the manufacture processes are simplified, and the assembling becomes convenient and costs can be reduced.

While the present disclosure is described with reference to some exemplary embodiments, these exemplary embodiments are not for limiting the present disclosure. One of ordinary skill in this art can make various changes and modifications without departing from the spirit and scope of the present disclosure. Thus, the protection scope of the present disclosure shall be defined by appended claims.

What is claimed is:

1. A fingerprint recognition mechanism, comprising:
a base plate;
a cover plate disposed over and separated from the base plate;
a touch panel disposed over the cover plate; and
a fingerprint recognition unit disposed between the base plate and the cover plate to emit electrical signals and recognize biometric features;
wherein the fingerprint recognition unit comprises:
a fingerprint module disposed below the cover plate and corresponding to a fingerprint sensing region of the touch panel; and
a signal transmission layer electrically coupled with the fingerprint module and configured to transmit the electrical signals to a part of limbs of a user, wherein the electrical signals are transmitted to another part of the limbs through the user so that the fingerprint module recognizes biometric features of the another part of the limbs of the user.

2. The fingerprint recognition mechanism according to claim 1, wherein the signal transmission layer comprises:
a conductive layer disposed below the cover plate and electrically coupled with the fingerprint module; and
a conductive frame disposed between the base plate and the cover plate and electrically coupled with the conductive layer.

3. The fingerprint recognition mechanism according to claim 2, wherein the fingerprint recognition unit further comprises a protection layer disposed on a surface of the fingerprint module and between the fingerprint module and the cover plate.

4. The fingerprint recognition mechanism according to claim 3, wherein the protection layer is made of transparent optical adhesive.

5. The fingerprint recognition mechanism according to claim 4, wherein the fingerprint module is attached to the cover plate via the protection layer.

6. The fingerprint recognition mechanism according to claim 1, wherein the fingerprint recognition unit further comprises an insulating layer disposed between the signal transmission layer and the cover plate.

7. The fingerprint recognition mechanism according to claim 1, wherein the electrical signals emitted from the fingerprint recognition unit are carrier waves of 100 KHz to 1 MHz.

8. The fingerprint recognition mechanism according to claim 1, wherein a plurality of fingerprint sensors are provided in the fingerprint module.

9. The fingerprint recognition mechanism according to claim 2, wherein the conductive layer is made of aluminum, copper, silver or indium tin oxide.

10. The fingerprint recognition mechanism according to claim 2, wherein the conductive frame is made of aluminum alloy or aluminum-magnesium alloy.

11. The fingerprint recognition mechanism according to claim 2, wherein the conductive layer and the conductive frame are formed integrally.

12. The fingerprint recognition mechanism according to claim 1, wherein the cover plate is formed by thin glass material.

13. An electronic device having a fingerprint recognition function, comprising a fingerprint recognition mechanism;
wherein the fingerprint recognition mechanism comprises:
a base plate;
a cover plate disposed over and separated from the base plate;
a touch panel disposed over the cover plate; and
a fingerprint recognition unit disposed between the base plate and the cover plate to emit electrical signals and recognize biometric features;
wherein the fingerprint recognition unit comprises:
a fingerprint module disposed below the cover plate and corresponding to a fingerprint sensing region of the touch panel; and
a signal transmission layer electrically coupled with the fingerprint module and configured to transmit the electrical signals to a part of limbs of a user, wherein the electrical signals are transmitted to another part of the limbs through the user so that the fingerprint module recognizes biometric features of the another part of the limbs of the user.

14. The electronic device according to claim 13, wherein the fingerprint recognition unit is disposed in a non-display region of the electronic device.

15. The electronic device according to claim 14, wherein the fingerprint recognition unit is disposed at the bottom of the electronic device.

16. The electronic device according to claim 13, wherein the conductive frame and a frame of the electronic device are formed integrally.

17. The electronic device according to claim 13, wherein the cover plate and a cover plate of the electronic device are formed integrally.

18. The electronic device according to claim 13, wherein the electronic device is a mobile phone.

19. A fingerprint recognition method using a fingerprint recognition mechanism, wherein the fingerprint recognition mechanism comprises:
a base plate;
a cover plate disposed over and separated from the base plate;
a touch panel disposed over the cover plate; and
a fingerprint recognition unit disposed between the base plate and the cover plate to emit electrical signals and recognize biometric features;
wherein the fingerprint recognition unit comprises:
a fingerprint module disposed below the cover plate and corresponding to a fingerprint sensing region of the touch panel; and
a signal transmission layer electrically coupled with the fingerprint module and configured to transmit the electrical signals to a part of limbs of a user, wherein the electrical signals are transmitted to another part of the limbs through the user so that the fingerprint module recognizes biometric features of the another part of the limbs of the user;
wherein the method comprises:
emitting electrical signals by the fingerprint module;
transmitting the electrical signals via the signal transmission layer to a part of limbs of a user, wherein the electrical signals is then transmitted to another part of the limbs through the user; and
recognizing, by the fingerprint module, biometric features of the another part of the limbs of the user acting upon the touch panel.

20. The method according to claim 19, wherein the electrical signals are transmitted from to one hand of the user and then to another hand of the user for recognition of biometric features.
